(19) United States
(12) Patent Application Publication
(10) Pub. No.: US 2025/0370002 A1
(43) Pub. Date: Dec. 4, 2025

(54) Controlled Indentation Instrumentation Working in Dynamical Mechanical Analysis Mode

(71) Applicant: Trustees of Tufts College, Medford, MA (US)

(72) Inventors: Igor Sokolov, Medford, MA (US); Maxim Dokukin, North Andover, MA (US)

(21) Appl. No.: 18/875,872

(22) PCT Filed: Jun. 23, 2023
(86) PCT No.: PCT/US2023/026050

§ 371 Date: Dec. 17, 2024

Related U.S. Application Data
(60) Provisional application No. 63/354,911, filed on Jun. 23, 2022.

(51) Int. Cl. G01Q 10/06; G01Q 60/36

(52) U.S. Cl. CPC G01Q 10/065; G01Q 60/366

(57) ABSTRACT

A method that includes controlling a contact parameter during a measurement of a dynamic property of a material that is a constituent of a sample by causing a probe to indent the sample until a stable value of a contact parameter has been achieved, during a fitting interval, exercising feedback control over the probe to maintain the value, and during a measurement interval, both causing the probe to oscillate towards and away from the material, and abandoning the feedback control over the probe.

### RELATED APPLICATIONS

This application claims the benefit of the Jun. 23, 2022 priority date of U.S. Provisional Application 63/354,911, the contents of which is herein incorporated by reference.

### STATEMENT OF GOVERNMENT SUPPORT

This invention was made with government support under grant 1937373 awarded by the National Science Foundation. The government has certain rights in the invention.

### FIELD OF INVENTION

The invention relates to measurement of mechanical properties and in particular to controlling the operation of an indentation instrument for analysis of dynamic properties of a mechanical system.

### BACKGROUND

Many materials deform in response to an applied loading force. The extent of this deformation depends on time. It is useful to quickly and accurately measure the response to an applied force.

The measurement process typically involves using a probe to indent the material. In response to indentation, the material deforms until it reaches an equilibrium state of deformation. At this point, contact is said to have stabilized. The time required to reach this point is indicative of the material's time-dependent properties, among which are creep or stress relaxation time. These are often referred to as “dynamic mechanical properties.”

It is possible to derive some information about these properties based on measurements of the material's response to the application of the load force. However, this information will be model dependent. As a result, it can fail to properly describe the material.

In an effort to reduce dependency on one's choice of a model, it is known to superimpose sinusoidal oscillations on a load force that the probe applies to the sample. This makes it possible to derive the time-dependent properties, for example, storage and loss moduli. In these measurements, the area of contact between the sample and the probe should remain constant.

Measurement thus requires waiting until the material's response to the indentation stabilizes. The waiting time for stabilization imposes a significant bottleneck on the speed with which the measurement process can be carried out.

Furthermore, since the contact area tends to increase during the material's relaxation, spatial resolution tends to become degraded.

### SUMMARY

A useful way to carry out measurements is to apply an oscillating loading force at one or more known frequencies, which define a spectrum of frequencies. This results in an oscillatory response of the sample material. The oscillatory response will have an in-phase component, which is in phase with the oscillating loading force, and a quadrature component, which is an out-of-phase component having an offset of ninety degrees from the loading force. The resulting oscillatory response provides information from which it is possible to estimate the material's dynamic mechanical properties and to do so with minimal reliance of any mechanical model or assumption concerning the material's time-dependent behavior, such as its viscoelastic or poroelastic behavior. In particular, provided that the contact area between the probe and the sample remains constant, the ratio of the in-phase and out-of-phase components, i.e., the loss tangent. is independent of any mechanical model.

In one aspect, the invention features a method that includes controlling a contact parameter during a measurement of a dynamic property of a material that is a constituent of a sample. Such a method includes causing a probe to indent the sample until a stable value of a contact parameter has been achieved, during a fitting interval, exercising feedback control over the probe to maintain the value, and during a measurement interval, both causing the probe to oscillate towards and away from the material, and abandoning the feedback control over the probe.

Practices of the method include those in which the contact parameter is a loading force applied to the probe and those in which the contact parameter is an extent to which the probe indents the material.

Also among the practices are those in which the probe is a probe to be a probe of an atomic-force microscope, those in which the probe is a constituent of a nano-indenter, and those in which the probe is a constituent of a scanning probe microscope.

Preferably, a control system maintains a constant contact area between the probe and the sample during the measurements. This avoids having to way for the contact area to stabilize during measurements. Advantages of such a control system include both increased speed and higher lateral resolution of measurements.

Additional practices include those in which the dynamic property is viscoelasticity those in which the dynamic property is poroelasticity, and those in which the dynamic property has first and second components that oscillate in phase and in phase quadrature, respectively, relative to an oscillation applied to the probe.

Practices include those that include, during the fitting interval developing a model for controlling the probe to maintain a stable contact parameter during the measurement interval and, during the measurement interval, attempting to maintain the contact parameter by extrapolating the model.

Other practices include, during the measurement interval, attempting to maintain the contact parameter based on a model for controlling the contact parameter.

Still other practices include, after the measurement interval, restoring the feedback control used during the fitting interval.

Also among the practices are those that further include identifying a discrepancy between the contact parameter upon completion of the measurement interval and a value of the contact parameter upon commencement of the measurement interval.

Still other practices include, during the measurement interval, attempting to cause the probe to maintain the value.

In one aspect, the invention features an apparatus for collecting and analyzing data to obtain information about dynamical properties of a material using an indentation apparatus, such as a nano-indenter or a scanning probe microscope. A control system keeps a constant area between an indenting probe and a sample during the measurements. This avoids having to wait for the contact area to stabilize during measurements. Advantages of such a control system include both increased speed and accuracy of measurements.

In some embodiments, the disclosed apparatus is usable as an add-on to an existing indenting apparatus. In other embodiments, an indenting apparatus incorporates the control apparatus described herein.

In another aspect, the invention features an apparatus for spectroscopic measurement of a dynamic property of a sample. Such an apparatus includes probe for indenting the sample, a controller comprising a controller card that executes controller for controlling oscillatory movement of the probe, and a processor for estimating the dynamic property based on the sample's response to the oscillatory movement.

Embodiments include those that include an atomic force microscope, with the probe being a constituent thereof, and those that include a nano-indenter, with the probe being a constituent thereof.

Still other embodiments include those in which the controller is configured to exercise feedback control over the probe and to abandon the feedback control during oscillatory movement of the probe.

In some embodiments, the controller is configured to cause the probe to carry out a fitting step and a measurement step that follows the fitting step. During the fitting step, the controller exercise feedback control over the probe and during the measurement step, the controller disables the feedback control.

In other embodiments, the controller is further configured to carry out an error-analysis step following the extrapolation step.

In still other embodiments, the controller is configured to cause the probe to execute a feedback loop to keep a contact parameter constant and to disable the feedback loop, and an error analysis step that follows the fitting step.

In another aspect, the invention includes a tangible and non-transitory computer-readable medium having encoded thereon instructions for causing the control card to execute the method described herein.

All implementations described herein are non-abstract implementations that have a technical effect. The claims therefore recite only subject matter that is non-abstract and that has technical effect. Any person who maintains otherwise would therefore merely be proving that it is possible for a person to incorrectly construe the claims notwithstanding a clear statement in the specification. As used herein, “non-abstract” is the converse of “abstract” as that term has been defined by the courts of the relevant jurisdiction as of the filing date of this application.

### BRIEF DESCRIPTION OF THE FIGURES

FIG. 1 shows an apparatus for measuring a dynamic property of a sample using a probe that indents the sample in a manner controlled by a controller card,

FIG. 2 shows an apparatus similar to that in FIG. 1 but with a scanning system having separate scanners, one of which applies the oscillatory motion.

FIG. 3 shows a method carried out by the controller card in FIGS. 1 and 2, and

FIG. 4 shows stages of a measurement using the method of FIG. 3.

### DETAILED DESCRIPTION

FIG. 1 shows a measurement apparatus 10 that measures dynamic mechanical properties of a sample 12. Examples of such properties include viscoelasticity and poroelasticity. the measurement apparatus 10 includes a probe 14 that contacts the sample 12 at selected points.

In some embodiments, the probe 14 is that of an atomic force microscope. In others, the probe 14 is that of a nano-indenter. Between these two options, an atomic force microscope provides a faster measurement with more reliable and precise force control and hence higher spatial resolution. Hence, having the probe 14 be that of an atomic force microscope is generally preferable.

The sample 12 comprises a material that demonstrate time-dependent deformation in response to an indentation. This deformation results from creep or stress relaxation.

To characterize a mechanical property of a sample 12, the probe 14 indents the sample 12. The sample's material responds by moving towards a new equilibrium state, cither by creep or by stress relaxation. Eventually, the sample 12 stabilizes at its new state. As a result, one must wait for the sample 12 to do so.

The need to wait for stabilization limits how fast measurement can be carried out. In addition, a contact area between the probe 14 and the sample 12 can increase while waiting. This tends to degrade spatial resolution of the measurement.

The measurement apparatus 10 as described herein reduces the waiting time and in so doing increases the rate at which measurements can be made while also improving spatial resolution. It does so by having the probe 14 apply a time-varying loading force to the sample 12 at some loading frequency. This results in measurement of two components of the sample's stress-to-strain ratio: a first component that oscillates in phase relative to the probe's oscillation and a second component that oscillates in quadrature relative to the probe's oscillation, i.e., with a ninety-degree phase shift relative to the probe's oscillation. Information about these two components is independent of any mechanical model or assumption of a specific viscoelastic or poroelastic behavior of the sample 12.

In carrying out measurements, there are two useful ways to control the probe 14. In both cases, a controlled parameter is held constant while a response parameter evolves over time as it asymptotically approaches an equilibrium value.

In the first method, the controlled parameter is loading force and the response parameter is indentation depth. In this method, the probe 14 applies a constant loading force. This results in a time-varying indentation depth that eventually reaches a stable depth.

In the second method, the controlled parameter is the indentation depth and the response parameter is a loading force exerted on the probe 14 by the sample 12 in response. In this method, the probe 14 maintains a stable indentation depth. This results in a time-varying loading force that eventually reaches a stable loading force.

In both cases, the onset of stability, whether it be that of the load force or the indentation depth, is referred to as “stable contact.” Thus, “stable contact” implies either a stable loading force or a stable indentation depth. The “loading force” and “indentation depth” are examples of a “contact parameter” that the measurement apparatus 10 controls.

A scanning system 16 under control of a processor 18 causes the probe 14 to translate along the sample 12 so that measurements can be made at selected points on the sample 12. The processor 18 also causes the probe 14 to engage in oscillatory motion towards and away from the sample 12 at some frequency.

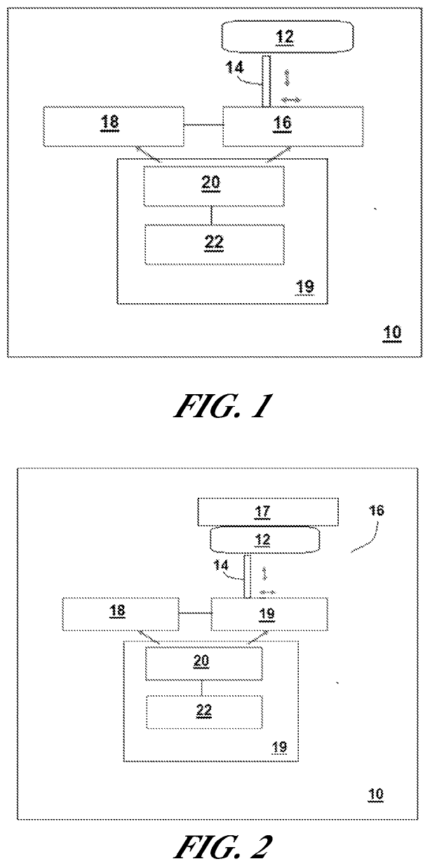

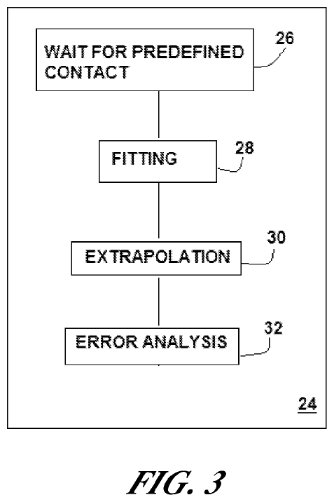

In some embodiments, as shown in FIG. 2, the scanning system 16 includes first and second scanners 17, 19 that are either mechanically connected to each other or separate. In a preferred embodiment the probe 14 is attached to the second scanner 19 and the sample is attached to the first scanner 17. In such an embodiment, the second scanner 19 causes the oscillatory motion.

In response to indentation by the probe 14, the sample 12 typically deforms. Then, slowly, the sample 12 complies until it reaches some stable equilibrium. This process is detectable by sensing the time evolution of contact between the probe 14 and the sample 12. During operation, the processor 18 collects information indicative of this time-varying contact for use in inferring the dynamic mechanical properties of the sample 12.

The measurement apparatus 10 further includes a controller 19 that is in data communication with the processor 18 and the scanner 16. The controller 19 includes a controller card 20 executes control software 22 that attempts to cause the probe 14 to maintain a constant contact parameter during measurements. In measurements of creep relaxation, the contact parameter that is to be kept constant is a loading force. In measurements of stress relaxation, the contact parameter that is to be kept constant is indentation depth. As used herein, a “contact” between the probe 14 and the sample 12 is said to be “stable” when the rate at which a contact parameter changes with time falls below a selected threshold as it asymptotically approaches its equilibrium value.

When making a measurement, stable contact should exist between the probe 14 and the sample 12. Doing so promotes accuracy in measurement.

To achieve stable contact, the controller 19 exercises feedback control over the probe 14. In feedback control systems, a controller controls a controlled value by manipulating a manipulated variable in response to measurements made of the controlled value. A problem that can arise in feedback control is that the controlled variable is changing too fast. As a result, by the time the controller obtains a measurement that measurement is obsolete.

When measuring a static mechanical property, the foregoing difficulty is unlikely to arise. However, when measuring a dynamic mechanical property, one superimposes a time-varying loading force onto whatever force the probe 14 is applying. This raises the foregoing difficulty.

When the probe 14 oscillates. the controller 19 abandons any attempt at feedback control over the probe 14. Instead, it controls the probe 14 by applying a model that represents an expected relationship between the force applied to the probe 14 and the contact parameter that is being maintained to be constant.

Referring to FIG. 3, a measurement process 24 carried out by the measurement apparatus 10 begins with a waiting step (step 26) in which the controller 19 awaits development of a predefined contact between the probe 14 and the sample 12. This contact is typically defined by measuring the load force as the probe 14 approaches and makes contact with the sample 12.

Upon detecting the onset of predefined contact, the controller 19 causes the measurement apparatus 10 to carry out a fitting step (step 28). During the fitting step (step 28). the controller 19 executes a feedback loop to control the probe 14 in such a way as to keep a contact parameter constant. In addition, the controller 19 records the probe's position on the sample 12. In preferred embodiments, the contact parameter is a loading force on the probe 14 or an indentation depth, i.e., the extent to which the probe 14 indents the sample 12.

The controller 19 then executes a measurement step (step 30). In doing so, the controller 19 disables the feedback loop that was being used to maintain the contact parameter (i.e., either loading force or indentation depth). It is at this point that the controller 19 also causes the probe 14 to begin oscillation. At the same time, the controller 19 extrapolates the probe's position into the future. The probe's vertical position during the extrapolation step (step 30) is thus dependent on this extrapolation. In effect, the controller 19 is carrying out a form of dead reckoning during this step.

In an optional error-detection step (step 32) that follows the measurement step (step 30), the controller 19 restores the feedback loop that was being used during the fitting step (step 28) and the processor 18 collects data concerning the change in the contact parameter, which, as noted above, can be an indentation depth or a loading force. This permits analysis of error in the feedback loop.

The apparatus 10 thus makes it possible to collect and analyze data so as to obtain information about dynamical mechanical properties of materials when using an indenting device, such as the probe 14, whether the probe 14 is a nano-indenter or part of a scanning probe microscope. The disclosed controller 19 allows one to keep the area between the indenting probe 14 and the sample 12 constant during the measurements. This avoids having to wait for stabilization of contact during the measurements. It also has a tendency to improve the accuracy of the measurement, its speed, or both. The apparatus 10 can be implemented as either an add-on to an existing indenting apparatus or in the design of an indenting apparatus.

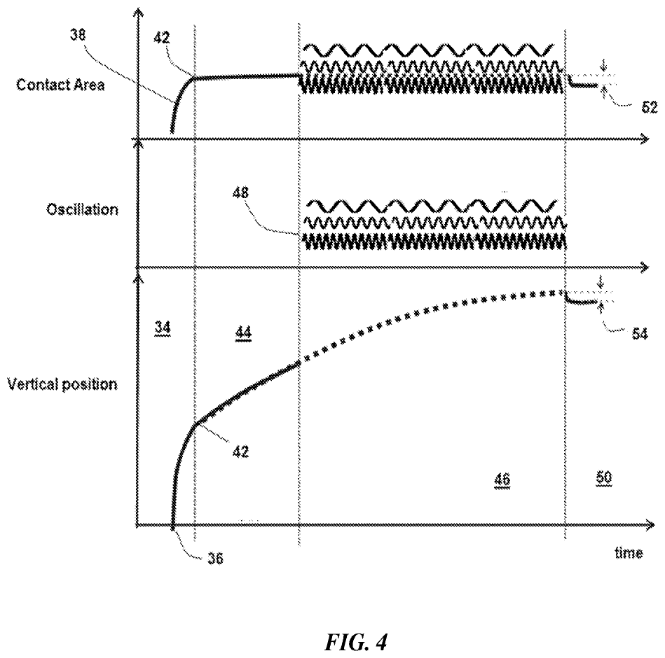

FIG. 4 shows an example in which the contact parameter is indentation depth.

As shown in FIG. 4, the measurement process begins with a waiting interval 34 during which the probe 14 moves towards the sample 12. Eventually, it makes first contact 36. The probe 14 continues to indent the sample 12, thus causing an increase 38 in contact area. At some point, the contact area arrives at a stable value 42, at which point stable contact is deemed to have been made.

During a fitting interval 44 that follows, the controller 19 executes a feedback loop to maintain the contact area. During this fitting interval 44, the probe 14 has yet to begin oscillating.

During a measurement interval 46 that follows the fitting interval 44, the controller 19 initiates oscillation 48. In addition, the feedback loop that was being used during the fitting interval 44 is turned off. Instead of controlling the probe's position using feedback, the controller 19 controls the probe's position based on this extrapolated position.

During an optional error-detecting interval 50 that follows the measurement interval 46, the controller 19 determines a contact parameter error 52 in an effort to identify an error 54 in the feedback loop. A useful basis for identifying such an error 54 is the deviation between a measurement of a parameter at the beginning of the measurement interval 46 and a measurement of the same parameter at the end of the measurement interval 46.

In the foregoing example, the model used to control the contact parameter during the measurement interval 46 is one that comes from extrapolation of a manipulated variable, i.e., the vertical position, during the fitting interval 44. However, in principle, another model can be used. For example, it is possible to use a different monotonic function, such as one obtained by a priori modeling the material of the sample 12. In some cases, control is carried out using one of a family of functions, with the correct function from the family having been selected based on goodness-of-fit.

Having described the invention and a preferred embodiment thereof, what is claimed as being new and secured by letters patent is:

1. A method comprising measuring a dynamic mechanical property of a material that is a constituent of a sample, wherein measuring said dynamic mechanical property comprises causing a probe to indent the sample until detecting the onset of predefined contact, during a fitting interval, exercising feedback control over said probe to maintain a contact parameter, and during a measurement interval, abandoning said feedback control over said probe, and during said measurement interval, causing said probe to oscillate towards and away from said material.

2. The method of claim 1, further comprising selecting said contact parameter to be a loading force applied to said probe.

3. The method of claim 1, further comprising selecting said contact parameter to be an extent to which said probe indents the material.

4. The method of claim 1, further comprising selecting said probe to be a probe of an atomic-force microscope.

5. The method of claim 1, further comprising selecting said probe to be a constituent of a nano-indenter.

6. The method of claim 1, wherein said method further comprises selecting said dynamic property to be viscoelasticity.

7. The method of claim 1, wherein said method further comprises selecting said dynamic property to be poroelasticity.

8. The method of claim 1, wherein said method further comprises selecting said dynamic property to be storage modulus.

9. The method of claim 1, wherein said method further comprises selecting said dynamic property to be loss modulus.

10. The method of claim 1, wherein causing said probe to oscillate results in an oscillation, wherein said method further comprises selecting said dynamic property to comprise a first component and a second component, wherein said first component oscillates in phase with said oscillation, and wherein said second component oscillates ninety degrees out of phase with said oscillation.

11. The method of claim 1, further comprising, during said fitting interval, developing a model for controlling said probe to maintain a stable contact parameter during said measurement interval and, during said measurement interval, attempting to maintain said contact parameter by extrapolating said model.

12. The method of claim 1, further comprising, during said measurement interval, attempting to maintain said contact parameter based on a model for controlling said contact parameter.

13. The method of claim 1, further comprising, after said measurement interval, restoring said feedback control used during said fitting interval.

14. The method of claim 1, further comprising identifying a discrepancy between said contact parameter upon completion of said measurement interval and a value of said contact parameter upon commencement of said measurement interval.

15. The method of claim 1, further comprising, during said measurement interval, attempting to cause said probe to maintain said value.

16. An apparatus for spectroscopic measurement of a dynamic property of a sample, said apparatus comprising a probe for indenting said sample, a controller comprising a controller card that executes control software for controlling oscillatory movement of said probe, and a processor for estimating said dynamic property based on said sample's response to said oscillatory movement.

17. The apparatus of claim 16, further comprising an atomic force microscope, wherein said probe is a constituent of said atomic force microscope.

18. The apparatus of claim 16, further comprising a nano-indenter, wherein said probe is a constituent of said nano-indenter.

19. The apparatus of claim 16, wherein said controller is configured to exercise feedback control over said probe and to abandon said feedback control during oscillatory movement of said probe.

20. The apparatus of claim 16, wherein said controller is configured to cause said probe to carry out a fitting step and a measurement step that follows said fitting step, wherein, during said fitting step, said controller exercise feedback control over said probe and wherein during said measurement step, said controller disables said feedback control.

21. The apparatus of claim 16, wherein said controller is further configured to execute a feedback loop to keep a contact parameter constant and to disable said feedback loop, and an error analysis step that follows said fitting step.

22. The apparatus of claim 16, further comprising a first scanner that moves said probe along a plane and a second scanner that moves said probe towards and away from said sample, wherein said controller controls said first and second scanners.

23. An article of manufacture comprising a tangible and non-transitory computer-readable medium having encoded thereon instructions for causing a controller to measure a dynamic mechanical property of a material that is a constituent of sample by causing a probe to indent the sample until a stable value of a contact parameter has been achieved, during a fitting interval, exercising feedback control over said probe to maintain said value, and during a measurement interval, causing said probe to oscillate towards and away from the material, and during said measurement interval, abandoning said feedback control over said probe.
